(19) United States
(12) Patent Application Publication
(10) Pub. No.: US 2026/0024397 A1
(43) Pub. Date: Jan. 22, 2026

(54) Cleaning Supply Dispensing and Collection Machine

(71) Applicants: Daniel Jardim, Maple (CA); Melissa Jardim, Maple (CA)

(72) Inventors: Daniel Jardim, Maple (CA); Melissa Jardim, Maple (CA)

(21) Appl. No.: 18/778,170

(22) Filed: Jul. 19, 2024

(51) Int. Cl. G07F 11/04; G07F 7/06

(52) U.S. Cl. CPC G07F 11/04; G07F 7/06

(57) ABSTRACT

A cleaning supply dispensing and collection machine includes a first housing that includes a supply compartment containing fresh cleaning supplies that are cleanable and reusable. A dispenser mechanism is designed to retrieve a selected number and type of fresh cleaning supplies from the supply compartment and a dispensing chute is operatively connected to the dispenser mechanism and exits the first housing. A second housing includes a collection compartment containing used cleaning supplies. A return device is positioned in the second housing and operatively connected to the collection compartment. A return sensor is designed to detect a number and type of used cleaning supplies returned via the return device. An electronic control system includes a microprocessor and a user interface to control operation of the cleaning supply dispensing and collection machine.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cleaning supply storage and collection and more particularly pertains to a new cleaning supply dispensing and collection machine for dispensing fresh cleaning supplies that are cleanable and reusable, such as mop heads and rags or cloths, and collecting used cleaning supplies. The machine is applicable to medical settings and other industries in which used cleaning supplies must regularly be collected for cleaning, and where tracking and controlling the dispensing and collection of the cleaning supplies would improve efficiency and reduce costs.

### (2) Description of Related Art Including Information Disclosed Under 37 CFR 1.97 and 1.98

The prior art relates to cleaning supply storage and collection. The prior art, as best understood, does not disclose a vending system for a hospital comprising a kiosk or stand which stores and dispenses a plurality of mops, rags, and other cleaning equipment, and has a receptacle for receiving soiled implements.

### BRIEF SUMMARY OF THE INVENTION

An embodiment of the disclosure meets the needs presented above in a cleaning supply dispensing and collection machine generally comprising a first housing that includes a supply compartment containing fresh cleaning supplies that are cleanable and reusable. A dispenser mechanism is designed to retrieve a selected number and type of fresh cleaning supplies from the supply compartment and a dispensing chute is operatively connected to the dispenser mechanism and exits the first housing. A second housing includes a collection compartment containing used cleaning supplies. A return device is positioned in the second housing and operatively connected to the collection compartment. A return sensor is designed to detect a number and type of used cleaning supplies returned via the return device. An electronic control system includes a microprocessor and a user interface to control operation of the cleaning supply dispensing and collection machine.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a cleaning supply dispensing and collection machine according to an embodiment of the disclosure.

FIG. 2 is a front view of an embodiment of the disclosure.

FIG. 3 is a rear view of an embodiment of the disclosure.

FIG. 4 is a side view of an embodiment of the disclosure.

FIG. 5 is a perspective view of a component of an embodiment of the disclosure.

FIG. 6 is a block diagram of components of an embodiment of the disclosure.

### DETAILED DESCRIPTION OF THE INVENTION

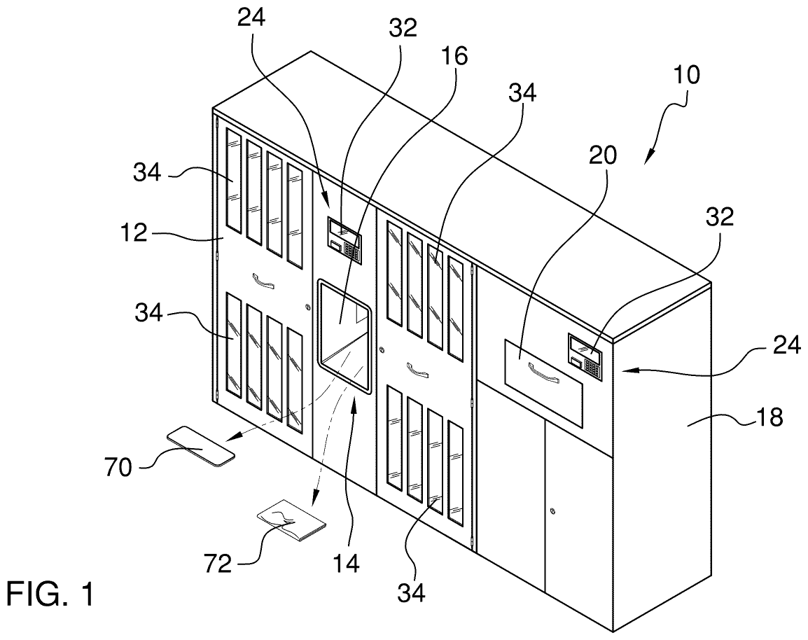

With reference now to the drawings, and in particular to FIGS. 1 through 6 thereof, a new cleaning supply dispensing and collection machine embodying the principles and concepts of an embodiment of the disclosure and generally designated by the reference numeral 10 will be described.

As best illustrated in FIGS. 1 through 6, the cleaning supply dispensing and collection machine 10 generally comprises a first housing 12, a dispenser mechanism 14, a dispensing chute 16, a second housing 18, a return device 20, a return sensor 22, and an electronic control system 24. The first housing 12 includes a supply compartment 26 containing fresh cleaning supplies that are cleanable and reusable. The dispenser mechanism 14 is designed to retrieve a selected number and type of fresh cleaning supplies from the supply compartment 26 and the dispensing chute 16 is operatively connected to the dispenser mechanism 14 and exits the first housing 12. The second housing 18 includes a collection compartment 28 containing used cleaning supplies. The return device 20 is positioned in the second housing 18 and operatively connected to the collection compartment 28. The return sensor 22 is designed to detect a number and type of used cleaning supplies returned via the return device 20. The electronic control system 24 includes a microprocessor 30 and a user interface 32 to control operation of the cleaning supply dispensing and collection machine 10.

The following description relates to one exemplary embodiment of the cleaning supply dispensing and collection machine 10, as shown in FIGS. 1 through 6, and other embodiments using different types and arrangements of components are within the scope of the disclosure, and thus the exemplary embodiment should not be understood as limiting the disclosure or claims to only the embodiment shown. The first housing 12 includes a viewing window 34 to permit a user to see the amount and type of fresh cleaning supplies in the supply compartment 26. Instead of a viewing window 34, a viewing screen could display the amount and type of fresh cleaning supplies in the supply compartment 26. The supply compartment 26 includes at least two sections 36, 38 containing at least two different types of fresh cleaning supplies, such as mop heads and cleaning rags or towels, as shown in FIG. 1. One section 36 includes a supply of the mop heads and another section 38 includes a supply of the cleaning rags. The supply compartment 26 could be designed to contain many different types of fresh cleaning supplies, and could contain an access door for the refilling of the supply compartment 26. In one possible embodiment, the supply compartment 26 is designed to hold about 1200 to 1700 mop heads and about 400 to 600 cleaning rags or towels.

The dispenser mechanism 14 is designed to retrieve a selected number and type of fresh cleaning supplies from the at least two sections 36, 38 of the supply compartment 26 and the dispensing chute 16 is operatively connected to the at least two sections 36, 38. It should be noted that the dispenser mechanism 14 is shown relatively schematically, though any mechanism suitable for use in retrieving and dispensing objects, such as the types of mechanisms used in vending machines or similar, could be incorporated into the cleaning supply dispensing and collection machine 10.

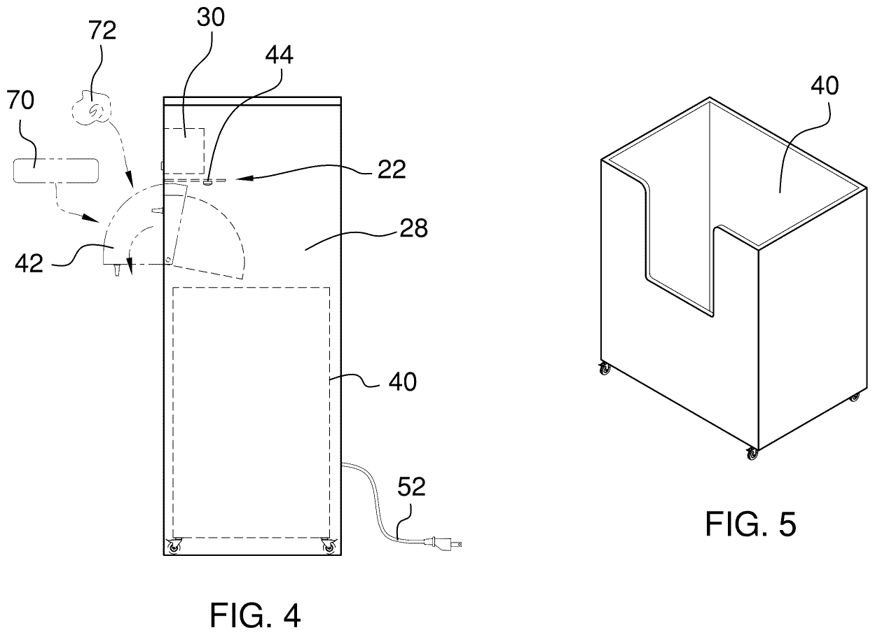

As shown in FIG. 5, the collection compartment 28 includes a removable collection bin 40. The collection compartment 28 could be designed to be opened and closed to permit a user to remove the collection bin 40 and either replace it or transfer the contents thereof into another container. A shown in FIG. 4, the return device 20 includes a pivotable return drawer 42 that is openable to receive used cleaning supplies and closable to transport used cleaning supplies into the collection compartment 28. While a pivotable return drawer 42 is shown, such as those in laundry chutes, mail boxes, or after-hours deposit units, other devices could be used, such as a vertical sliding door and a chute device. As shown in FIG. 4, the return sensor 22 includes a camera 44 positioned adjacent the return device 20. The camera 44 could be used to identify the number and type of used cleaning supplies returned via the return drawer 42. In addition or alternatively, the user could input the number and type of used cleaning supplies being returned into the user interface 32, which could be verified via the sensor device or accepted as accurate if the sensor device is omitted or inoperable or malfunctioning.

As shown in FIG. 1, the second housing 18 is attached to the first housing 12. In one possible embodiment, the first housing 12 and second housing 18 are integral with one another. In another possible embodiment, the first housing 12 and the second housing 18 could be positioned apart from one another as independent units.

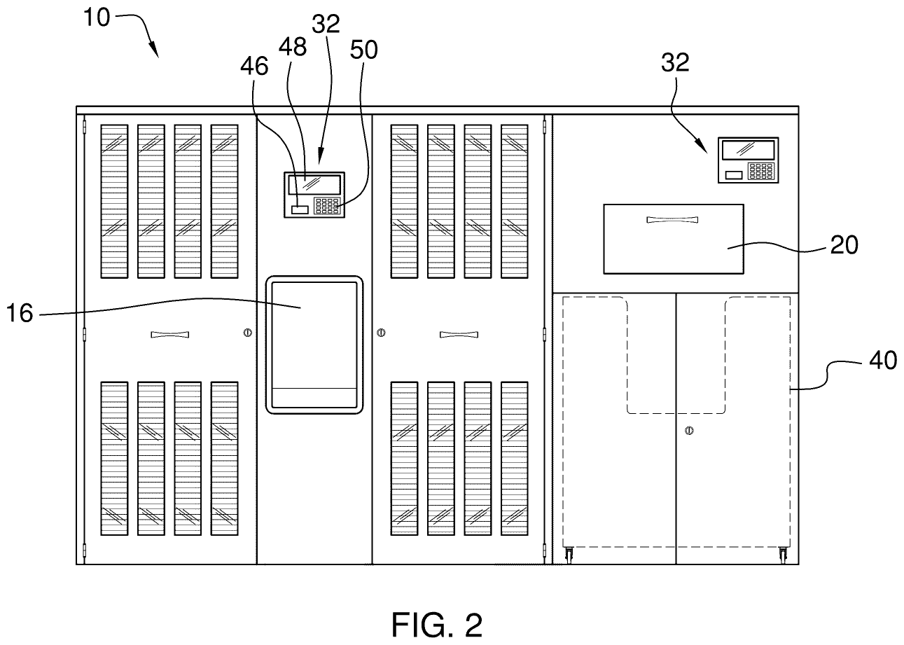

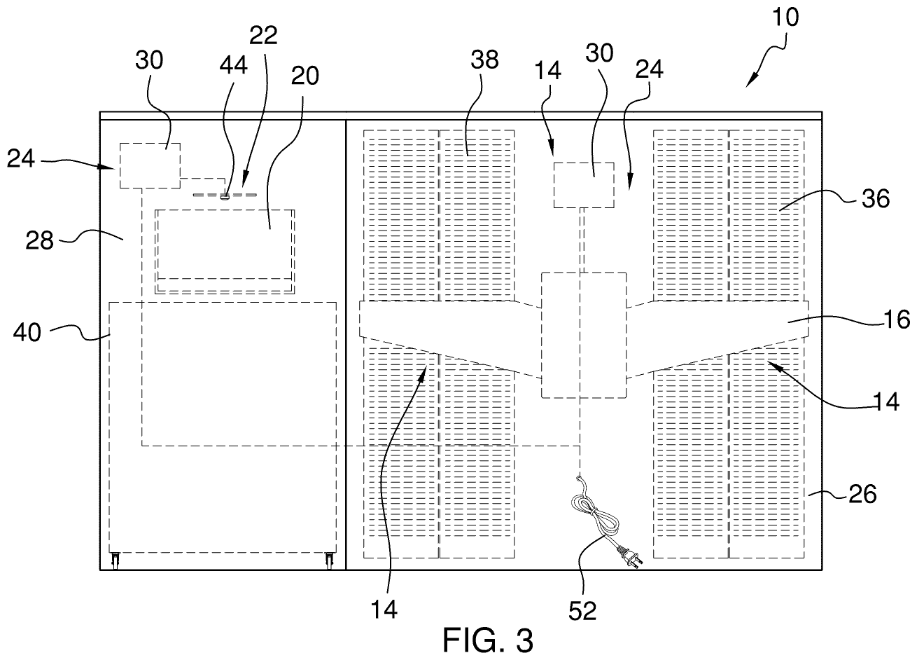

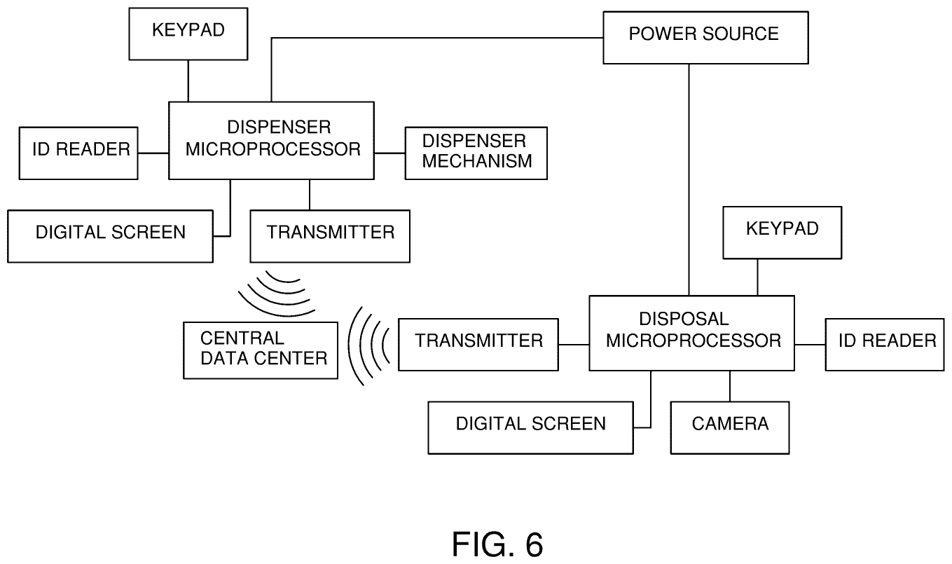

As shown in FIG. 2, the user interface 32 includes an ID reader 46 designed to read an ID badge of a user and transmit that information to the microprocessor 30. The user interface 32 also includes a digital screen 48 and keypad 50 to permit a user to input information relating to the dispensing of fresh cleaning supplies and the collection of used cleaning supplies. In the embodiment shown in FIG. 2, there are two separate user interfaces 32, one to control dispensing and the other to control collection, though only one user interface 32 could be used that is common to both functions. In addition, as shown in FIG. 3, two separate microprocessors 30 could be used, though only one microprocessor 30 could be utilized in one possible embodiment. An electric cord 52 is provided as a common power source for the different components of the cleaning supply dispensing and collection machine 10, as represented schematically in FIG. 6. The microprocessor 30 includes a memory designed to store the number and type of fresh cleaning supplies dispensed to a user and the number and type of used cleaning supplies returned by a user. The cleaning supply dispensing and collection machine 10 could include one or more wireless transmitters that could be operatively connected to the microprocessor 30 for the transmission of data to a central data center, as shown schematically in FIG. 6.

To use the cleaning supply dispensing and collection machine 10, a user, such as a hospital worker or worker in a similar industry that cleans and reuses cleaning supplies, engages the user interface 32 and selects a number and type of fresh cleaning supplies, such as mop heads 70 and cleaning rags 72 as shown in FIG. 1. The dispenser mechanism 14 retrieves the selected number and type of fresh cleaning supplies from the supply compartment 26 and dispenses them via the dispensing chute 16. In one possible embodiment, the microprocessor 30 will have a minimum and maximum number of fresh cleaning supplies that may be dispensed at one time to a user, such as about five to about 25. As shown in FIG. 4, when the user wants to return used cleaning supplies, such as a used mop head 70 and used cleaning rag 72, the user engages the user interface 32, though in one embodiment this could be optional or omitted, and returns a number and type of used cleaning supplies via the return device 20 into the collection compartment 28, such as by tipping open the return drawer 42 and then tipping it back to drop the used cleaning supplies into the collection bin 40. The return sensor 22 detects the number and type of used cleaning supplies returned via the return device 20. When engaging the user interface 32, either when dispensing fresh cleaning supplies or returning used cleaning supplies, the user may first scan an ID badge connected to that user. In this manner, the number and type of fresh cleaning supplies dispensed to a user and the number and type of used cleaning supplies returned by the user can be tracked and stored in the memory of the microprocessor 30. The cleaning supply dispensing and collection machine 10 can then control the number and type of additional fresh cleaning supplies dispensed to the user based on the number and type of used cleaning supplies returned by the user. For example, if the user has obtained 20 cleaning rags and only returned 12, the cleaning supply dispensing and collection machine 10 will not dispense more cleaning rags to that user until the remaining eight have been returned. In this manner, users will be encouraged if not required to return used cleaning supplies before obtaining additional fresh cleaning supplies.

In addition, as shown in FIG. 6, the microprocessor 30 can be operatively connected to a remote central computer, which allows for tracking a total number and type of fresh cleaning supplies dispensed and a total number and type of used cleaning supplies returned for the cleaning supply dispensing and collection machine 10. Such a design would help management better control operations. For example, in many hospitals, at the start of each shift, hospital cleaning staff will pick up clean and sanitized mops and rags from the hospital laundry room which they will need to use during their shift. At the end of each shift, the staff are expected to return all soiled mops and rags to a soiled laundry bin located in the hospital laundry room. An external company that provides laundry services for mops and rags then comes to the hospital and picks up only the soiled mops and rags that staff have returned at the end of their shifts. Since not all mops and rags are returned, the laundry service is unable to return the actual amount that the hospital needs. In other words, they can only bring back what they pick up. For example, a hospital might use on a daily basis about 1600 mops and rags. If the staff return only 1000 mops and rags for cleaning, then the external company will only replace 1000 mops and rags, leaving a shortage of 600 mops and rags that the hospital must address. By tracking this information centrally, as well as at the cleaning supply dispensing and collection machine 10, the dispensing of fresh cleaning supplies in relation to used cleaning supplies can be better controlled, thereby minimizing wasted time and resources.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cleaning supply dispensing and collection machine comprising:
a first housing comprising a supply compartment containing fresh cleaning supplies that are cleanable and reusable;
a dispenser mechanism configured to retrieve a selected number and type of fresh cleaning supplies from said supply compartment and a dispensing chute operatively connected to said dispenser mechanism and exiting said first housing;
a second housing comprising a collection compartment containing used cleaning supplies;
a return device disposed in said second housing and operatively connected to said collection compartment;
a return sensor configured to detect a number and type of used cleaning supplies returned via said return device; and
an electronic control system comprising a microprocessor and a user interface to control operation of the cleaning supply dispensing and collection machine.

2. The cleaning supply dispensing and collection machine of claim 1, wherein said first housing comprises a viewing window to permit a user to see the amount and type of fresh cleaning supplies in said supply compartment.

3. The cleaning supply dispensing and collection machine of claim 1, wherein said supply compartment comprises at least two sections containing at least two different types of fresh cleaning supplies.

4. The cleaning supply dispensing and collection machine of claim 3, wherein one of said at least two sections comprises a supply of mop heads and another of said at least two sections comprises a supply of cleaning rags.

5. The cleaning supply dispensing and collection machine of claim 3, wherein said dispenser mechanism is configured to retrieve a selected number and type of fresh cleaning supplies from said at least two sections of said supply compartment and said dispensing chute is operatively connected to said at least two sections.

6. The cleaning supply dispensing and collection machine of claim 1, wherein said collection compartment comprises a removable collection bin.

7. The cleaning supply dispensing and collection machine of claim 1, wherein said second housing is attached to said first housing.

8. The cleaning supply dispensing and collection machine of claim 1, wherein said return device comprises a pivotable return drawer that is openable to receive used cleaning supplies and closable to transport used cleaning supplies into said collection compartment.

9. The cleaning supply dispensing and collection machine of claim 1, wherein said return sensor comprises a camera disposed adjacent said return device.

10. The cleaning supply dispensing and collection machine of claim 1, wherein said user interface comprises an ID reader configured to read an ID badge of a user and transmit that information to said microprocessor.

11. The cleaning supply dispensing and collection machine of claim 1, wherein said user interface comprises at least one of a digital screen and keypad to permit a user to input information relating to the dispensing of fresh cleaning supplies and the collection of used cleaning supplies.

12. The cleaning supply dispensing and collection machine of claim 1, wherein said microprocessor comprises a memory configured to store the number and type of fresh cleaning supplies dispensed to a user and the number and type of used cleaning supplies returned by a user.

13. A method of using the cleaning supply dispensing and collection machine of claim 1, comprising the steps of:
a user engaging said user interface and selecting a number and type of fresh cleaning supplies;
retrieving with said dispenser mechanism the selected number and type of fresh cleaning supplies from said supply compartment and dispensing them via said dispensing chute;
the user engaging said user interface and returning a number and type of used cleaning supplies via said return device into said collection compartment; and
detecting the number and type of used cleaning supplies returned via said return device.

14. The method of claim 13, wherein said user interface comprises an ID reader configured to read an ID badge of a user and transmit that information to said microprocessor, and said microprocessor comprises a memory configured to store the number and type of fresh cleaning supplies dispensed to a user and the number and type of used cleaning supplies returned by a user, wherein said method further comprises tracking the number and type of fresh cleaning supplies dispensed to a user and the number and type of used cleaning supplies returned by the user, and controlling the number and type of additional fresh cleaning supplies dispensed to the user based on the number and type of used cleaning supplies returned by the user.

15. The method of claim 13, wherein said microprocessor is operatively connected to a remote central computer, and said method further comprises tracking a total number and type of fresh cleaning supplies dispensed and a total number and type of used cleaning supplies returned.

16. A cleaning supply dispensing and collection machine comprising:
a first housing comprising a supply compartment containing fresh cleaning supplies that are cleanable and reusable, wherein:
said first housing comprises a viewing window to permit a user to see the amount and type of fresh cleaning supplies in said supply compartment,
said supply compartment comprises at least two sections containing at least two different types of fresh cleaning supplies,
one of said at least two sections comprises a supply of mop heads and another of said at least two sections comprises a supply of cleaning rags;
a dispenser mechanism configured to retrieve a selected number and type of fresh cleaning supplies from said supply compartment and a dispensing chute operatively connected to said dispenser mechanism and exiting said first housing, wherein:
said dispenser mechanism is configured to retrieve a selected number and type of fresh cleaning supplies from said at least two sections of said supply compartment and said dispensing chute is operatively connected to said at least two sections;
a second housing comprising a collection compartment containing used cleaning supplies, wherein:
said collection compartment comprises a removable collection bin,
said second housing is attached to said first housing;
a return device disposed in said second housing and operatively connected to said collection compartment, wherein;
said return device comprises a pivotable return drawer that is openable to receive used cleaning supplies and closable to transport used cleaning supplies into said collection compartment;
a return sensor configured to detect a number and type of used cleaning supplies returned via said return device, wherein:
said return sensor comprises a camera disposed adjacent said return device; and
an electronic control system comprising a microprocessor and a user interface to control operation of the cleaning supply dispensing and collection machine, wherein:
said user interface comprises an ID reader configured to read an ID badge of a user and transmit that information to said microprocessor,
said user interface comprises at least one of a digital screen and keypad to permit a user to input information relating to the dispensing of fresh cleaning supplies and the collection of used cleaning supplies,
said microprocessor comprises a memory configured to store the number and type of fresh cleaning supplies dispensed to a user and the number and type of used cleaning supplies returned by a user.
